(19) United States
(12) Patent Application Publication
(10) Pub. No.: US 2024/0339634 A1
(43) Pub. Date: Oct. 10, 2024

(54) Device and Method for Electrically Contacting a Fuel Cell Assembly, and System Having the Device

(71) Applicant: Bayerische Motoren Werke Aktiengesellschaft, Muenchen (DE)

(72) Inventors: Patrik LOFERER, Oberschleissheim (DE); Lukas MEIER, Regensburg (DE); Marco ZOESCH, Vaterstetten (DE)

(21) Appl. No.: 18/575,916

(22) PCT Filed: Jul. 1, 2022
(86) PCT No.: PCT/EP2022/068273

§ 371 Date: Jan. 2, 2024

(30) Foreign Application Priority Data
Jul. 1, 2021 (DE) 10 2021 116 956.9

(51) Int. Cl. H01M 8/0247; H01R 13/627; H01R 13/629; H01R 13/639

(52) U.S. Cl. CPC H01M 8/0247; H01R 13/6271; H01R 13/629; H01R 13/639

(57) ABSTRACT

A device is disclosed for electrically contacting a fuel cell assembly having a plurality of bipolar plates. The device has a plurality of connector elements which are each designed to be electrically connected to a contacting portion of one of the bipolar plates, a housing which has a first guide portion and is designed to at least partly receive the connector elements, and a separate positioning part having a holding portion which is designed to hold each of the contacting portions in its own predetermined position relative to the positioning part, and having a second guide portion which is designed to guide the housing towards the holding portion from a first position into a second position by interacting with the first guide portion. The connector elements which are at least partly received in the housing are, in the first position, spaced apart from the contacting portions which are held by the holding portion and, in the second position, contact the contacting portions which are held by the holding portion.

### BACKGROUND AND SUMMARY

The present invention relates to a device for electrically contacting a fuel cell assembly having a plurality of bipolar plates, to a system containing the device, and to a method for electrically contacting a fuel cell assembly having a plurality of bipolar plates.

Fuel cells make it possible to convert chemical energy of a continuously supplied fuel directly into electrical energy, and are therefore suitable in particular for efficient power generation in modern means of transport, such as motor vehicles or aircraft. They generally comprise an anode, a cathode and an eponymous electrolyte arranged between the anode and cathode, and can be assembled to form fuel cell stacks. A polymer electrolyte (PEM) fuel cell stack has, for example, two end plates and a plurality of bipolar plates between the end plates, wherein the bipolar plates in turn are separated by membrane electrode assemblies (what are referred to as MEAs). The bipolar plates here in each case in principle form the anode of a fuel cell of the stack and the cathode of an adjacent fuel cell of the stack and are provided with a conventionally meandering fluid duct for the fuel or the oxidant. The membrane electrode assemblies each generally consist of a proton-conducting membrane and electrodes which are arranged on both sides of the membrane and as a rule in each case have a catalytic layer and a porous gas diffusion layer.

In order to monitor the electrical potentials of the fuel cells and control of the electrochemical processes on the basis thereof, it is known from the prior art to electrically contact the bipolar plates. For example, the document EP 1 001 666 A2 describes a contacting device for a fuel cell stack, the contacting device having a carrier layer and a plurality of electrically conductive regions, wherein in particular electrically conductive layers are formed on the carrier layer and layers separating the electrically conductive layers are formed from an electrically insulating material. The electrically conductive layers are in physical and electrical contact with an edge of an electrically conductive fuel-distributing separating plate of the fuel cells.

Against this background, it is an object of the present invention to provide a device for electrically contacting a fuel cell assembly having a plurality of bipolar plates, with which device contacting portions of the bipolar plates can be contacted rapidly, simply and nevertheless precisely. Furthermore, it is an object of the present invention to provide a corresponding system and a corresponding method.

This object is achieved by a device for electrically contacting a fuel cell assembly, by a system having such an assembly, and by a method for electrically contacting a fuel cell assembly, in accordance with the independent claims.

The device is provided for electrically contacting a fuel cell assembly which has a plurality of bipolar plates each having a contacting portion, and it comprises a plurality of connector elements, a housing for the connector elements, and a separate positioning part. The connector elements are each designed to be electrically connected to a contacting portion of one of the bipolar plates. The housing has a first guide portion and is designed to at least partially receive the connector elements. The separate positioning part comprises a holding portion which is designed to hold each of the contacting portions to a position predetermined for it relative to the positioning part, and a second guide portion which is designed to guide the housing from a first position in the direction of the holding portion into a second position by interaction with the first guide portion. In the first position, the connector elements at least partially received in the housing are spaced apart from the contacting portions held by means of the holding portion and, in the second position, the connector elements at least partially received in the housing contact (preferably electrically and physically) the contacting portions held by means of the holding portion.

The fuel cell assembly can be in particular part of a fuel cell stack. The bipolar plates can comprise a plurality of plate-like portions (for example anode/cathode of adjacent unit cells) which are connected conductively to one another and are therefore at the same potential. In particular, the bipolar plates can delimit the unit cells of the fuel cell assembly. The contacting portion is preferably designed as a tab in an edge region of the respective bipolar plate. The housing for the connector elements and the separate positioning part are preferably in each case molded parts, in particular plastics molded parts. They can be formed as a single piece, in particular monolithically (free from joining points). Preferably, the housing and/or the separate positioning part are each produced from an insulating material, in particular from a plastic.

Within the present context, separately can mean that the positioning part is designed as a body independent of the housing. In particular, the housing can be designed as a plastics cast part and the positioning part as a different plastics cast part. The positioning part is preferably connectable in a force-fitting manner to the housing and/or is detachable reversibly therefrom without being destroyed. The housing can preferably be inserted into a receptacle formed on the positioning part and/or removed (in particular reversibly) from the receptacle. If the housing is in its state detached from the positioning part, the housing can be able to be shifted in an axially sliding manner freely relative to the positioning part or on the positioning part. If the positioning part is connected in a force-fitting manner to the housing, the housing can be clamped in the receptacle.

The device according to the invention advantageously enables the bipolar plates, in particular the contacting portions of the bipolar plates, to be contacted rapidly, efficiently and precisely. In particular, the separate positioning part can be plugged simply onto the bipolar plates in the region of the contacting portions in order to hold them in the respectively predetermined position on the positioning part. This controlled pre-positioning of the contacting portions affords the additional advantage that manufacturing tolerances relating to the position of the bipolar plates can easily be compensated for in order to be able to carry out the actual contacting step, i.e. the production of the electrical connection between the connector elements and the contacting portions, virtually immediately without significant manual corrections.

The fuel cell assembly can therefore not only be produced more rapidly and simply, but substantially more precisely because of the synergistic interaction between the components of the device, namely the connector elements, the housing and the separate positioning part. Consequently, the risk of retrospectively required corrections of erroneous contactings, in particular double occupations of one connector element with contacting portions of adjacent bipolar plates, is significantly reduced in a synergistic manner. The same applies to the risk of damage to the bipolar plates. The device according to the invention can therefore even permit automated populating of the fuel cell assembly with the connector elements. At the same time, the distances between the bipolar plates can be reduced in order to save on construction space.

The connector elements are preferably designed as terminals which can each clamp one of the contacting portions at its edge portion when the connector elements are received in the housing and the housing is arranged in the second position. The terminals can be beak-shaped. In particular, the connector elements/terminals can be formed with at least two preferably elastic terminal limbs which can be aligned parallel to the contacting portion of the bipolar plate when they clamp the respective contacting portion while the housing is in the second position. If the connector elements are plugged onto the contacting portions, the former is therefore (only slightly) elastically bent upward and the contacting portions each enter into engagement with them. The contact between the connector elements and the contacting portions of the fuel cell assembly can therefore be reversible such that the device can be removed from the fuel cell assembly in order to investigate the latter, for example retrospectively, for errors.

Furthermore, the connector elements can each have a connecting portion for an electrical line on their sides opposite the terminal limbs. The connecting portions can be designed for crimping or soldering-on the electrical line and can be arranged on that side of the housing which is opposite the positioning part when the housing is in its second position. In particular, the connecting portions can project on this side beyond the housing in order to be able to connect the electrical line comparatively simply to the respective connector element when the respective connector element is in engagement with the housing.

The housing is preferably provided with cutouts, in particular through openings, which are each designed for at least partially receiving one of the connector elements. When the respective connector element is partially received in the through opening, it can protrude beyond the housing at one or both ends of the through opening. The through openings preferably have a substantially rectangular cross section and can be dimensioned in such a manner that in each case one of the connector elements fits into one through opening. For the form-fitting or force-fitting, in particular latching, connection of the connector elements to the housing, it can be provided that the connector elements are each provided with a first latching portion and the cutouts/through openings are each provided with a second latching portion. The first latching portion can comprise a latching lug or a latching tab and the second latching portion can comprise a groove or depression. Conversely, the first latching portion can comprise a groove or depression and the second latching portion can comprise a latching lug or a latching tab.

In one variant, a plurality of the connector elements or of the through openings are arranged in the housing grouped along a plurality of planes running parallel to one another. In other words, a first group of the through openings is arranged in the housing along a first longitudinal sectional plane containing the longitudinal axes of the through openings of the first group and a second group of the through openings is arranged in the housing along a second longitudinal plane containing the longitudinal axes of the through openings of the second group. The first and second longitudinal sectional planes therefore run in particular perpendicularly to the contacting portions when the holding portion holds the contacting portions and the housing is in the second position. The direction which is predetermined by the longitudinal axes of the cutouts/through openings or of the connector elements received therein is hereinafter also referred to as axial.

In the cross section perpendicular to the longitudinal sectional planes, the through openings of the first group are advantageously offset laterally relative to the through openings of the second group. The distances between the through openings (“pitch”) are preferably substantially identical in the two longitudinal sectional planes. The contacting portions of the bipolar plates can therefore be contacted on different levels relative to the first or second guide portion when the housing is in the second position. In this way, fuel cell assemblies still having a small distance between the contacting portions can be contacted simply and efficiently. Conversely, with simple contacting, the fuel cell assembly/the fuel cell stack can be constructed even more compactly.

It has been stated that the holding position is designed to hold each of the contacting portions at a position predetermined for it relative to the positioning part. The term “holding” here can mean limiting a relative movement between the holding portion and the contacting portions (at least in a direction transversely with respect to the main surfaces of the bipolar plates). The contacting portions can be in engagement with the holding portion. In particular, the holding portion (i.e. one and the same holding portion) can be designed to at least partially receive and/or to clamp the (plurality of) contacting portions. The contacting portions can therefore (in particular directly) contact the holding portion at least in regions. In one variant, the holding portion can be designed to fix each of the contacting portions at the predetermined position. In addition, the holding portion is preferably designed to fix the position of the contacting portions relative to the positioning part, optionally also relative to the housing located in the second position, when the contacting portions are brought into engagement with the holding portion. The fixing can in particular be undertaken in such a manner that the contacting portions are located in predetermined regions of the positioning part. In order to pre-position the contacting portions for the contacting by the connector elements received on the housing, it can be provided in particular that the holding portion has a plurality of slots, of which each is assigned to one of the contacting portions. The pitch (center distance) of the slots therefore substantially corresponds (apart from manufacturing tolerances) to the mean pitch of the contacting portions over the fuel cell assembly.

The slots are preferably formed on a side of the holding portion opposite the housing and are preferably aligned axially/parallel relative to the connector elements. Stated more precisely, each slot preferably runs along the longitudinal axis of an associated connector element, which is at least partially received in the housing, when the housing is in its second position. The slots can furthermore taper from an end facing away from the housing in the second position into the positioning part in order to assist the alignment of the contacting portions for the contacting by the connector elements.

In one variant, the contacting portions are fixed by means of the holding portion. In particular, the contacting portions can be partially received in a form-fitting manner in the slots or can even be clamped in a force-fitting manner in the slots. Along the longitudinal axes of the connector elements, further openings can be formed in the positioning part, said openings preferably extending from a surface facing the housing in its second position in the direction of the holding portion into the positioning part as far as the slots. These openings can in particular form a connection for the connector elements between the through openings and the slots.

When the housing is in its first position relative to the positioning part, it is connected to the positioning part in a freely movable manner in all directions in space or at least in a form-fitting manner by interaction between the first and the second guide portion. In a form-fitting manner here can mean in particular a limitation of the movability in the transverse direction, i.e. transversely with respect to the longitudinal axes of the connector elements/through openings. If, by contrast, the housing is in its second position, it is preferably connected in a force-fitting manner to the positioning part. In this case, the housing can be supported in particular on a surface of the separate positioning part opposite the holding portion.

In order to guide the housing, preferably with the connector elements already partially received therein, particularly precisely and easily from its first position into its second position, the second guide portion can have a rail and the first guide portion can have a slider which can be brought into engagement with the rail, and is preferably fixedly connected to the housing, most preferably is formed integrally with the housing. Alternatively, the second guide portion can comprise the slider and the first guide portion can comprise the rail. The rail is preferably aligned axially, i.e. it preferably runs parallel to the longitudinal axes of the through openings and/or slots. When the slider is in engagement with the rail in the first position of the housing, it can be shifted axially along the rail in engagement with the rail until the housing is in the second position. In the first and/or in the second position, the holding portion can be arranged between the housing and a center of at least one of the bipolar plates. The holding portion can furthermore be at least partially arranged between the housing and the contacting portion, in particular when the housing is located in the first and/or in the second position.

A play of the housing in one or a plurality of its mutually orthogonal transverse directions is continuously reduced from the first position towards the second position by interaction between the first and the second guide element. This is preferably realized in that the rail is tapered. In particular, the rail can preferably taper in respect of its width from its end facing away from the holding portion as the distance to the holding portion becomes smaller. It is also conceivable to configure the rail to be conical on the inside.

By contrast, the slider can have a constant width or can likewise be conical, with it being narrower on a side facing the holding portion than on a side facing away from the holding portion. In this way, the slider can be received with play transversely with respect to the longitudinal direction of the rail when the housing is in the first position. In the second position of the housing, the slider is, by contrast, preferably fixed by the rail in one or both mutually orthogonal transverse directions, i.e. is immovable in particular transversely with respect to the longitudinal direction of the rail.

In addition, the positioning part can be provided with a base portion extending from the holding portion in particular substantially parallel to the latching arm and/or substantially perpendicularly to a surface of the positioning part facing the housing in its second position. The housing can rest in its first position on the base portion and/or in a second position can be clamped between the resilient latching arm and the base portion. The base portion is preferably designed as a plate running axially with respect to the positioning part. The plate can have a plurality of longitudinal slots.

In order to fix the housing not only transversely, but also axially with respect to the longitudinal direction of the rail, it is provided, in a further variant, that the second guide portion has an, in particular resilient, latching arm extending from the holding portion or is designed as the latching arm. Preferably, the rail is designed as an integral part of the latching arm and likewise extends from the holding portion. The latching arm is provided in particular with a projection which is designed to act on the housing on a side of the housing opposite the holding portion in order to clamp the housing (in particular elastically) between the holding portion and the projection. The projection can face the base portion. The distance between the projection and the holding portion preferably substantially corresponds to the axial length of the housing. When the connector elements, in the second position of the housing, protrude beyond the latter on a side of the housing facing the holding portion, the connector elements therefore engage in the holding portion and extend in particular as far as into the slots.

In addition, the latching arm can have a latching lug on its side opposite the holding portion for engagement in a corresponding groove in the contacting portion. The latching lug can extend in particular over the entire transverse width of the latching arm and can thus engage in the grooves of the contacting portions of a plurality of adjacent bipolar plates to be contacted by means of the device. As a result, the secure contacting and latching of the fuel cell assembly can be undertaken rapidly and simply. The latching lug is preferably arranged on an outer side of the latching arm opposite the projection or the housing in the second position. In this case, at an end facing away from the holding portion, the latching arm is preferably provided with a tab, which extends axially from the latching arm, for releasing the engagement between the latching lug and the groove. The device can therefore be attached efficiently to the fuel cell assembly and easily removed therefrom.

The system proposed here has a device described above in detail and a fuel cell assembly which can be electrically contacted by means of the device and has a plurality of bipolar plates. Each of the contacting portions can have a recess in its edge region for partially receiving the device. When the housing is located in its second position and the contacting portions are contacted by means of the connector elements, i.e. the device is in engagement with the contacting portions, a contour of the recess preferably substantially corresponds to a contour of the device in a longitudinal section, as viewed along a main plane of the respective contacting portion. In particular, the contacting portion can be in engagement with an associated slot while the positioning part can be supported axially outside the slot on the contacting portion.

The method for contacting a fuel cell assembly having a plurality of bipolar plates comprises the following steps which are preferably carried out in the sequence indicated here: providing a device, described in detail above, or a system, described in detail above; connecting the connector elements to the housing, wherein the connector elements are at least partially received in the housing; connecting the separate positioning part to the contacting portions such that each of the contacting portions is held at a position predetermined for it relative to the positioning part; guiding the housing, by interaction between the first guide portion and the second guide portion, from a first position, in which the connector elements are spaced apart from the contacting portions, in the direction of the holding portion of the positioning part into a second position, in which the connector elements contact the contacting portions. In particular, the step of connecting the separate positioning part to the contacting portions can begin and/or be carried out before the step of guiding the housing. The connecting of the separate positioning part to the contacting portions can comprise bringing the contacting portions into engagement with the holding portion.

Furthermore, this method can have any of the features described above in conjunction with the device or with the system. In particular, the method can contain any desired functions of the device or of the system and the components thereof as method steps.

Preferred embodiments of a device for computer-tomographic testing of a test object will now be explained more precisely with reference to the attached schematic drawings.

### BRIEF DESCRIPTION OF THE DRAWINGS

FIG. 1 shows an embodiment of a device for electrically contacting a fuel cell assembly having a plurality of bipolar plates in a perspective view, wherein the connector elements, the housing and the positioning part are separated from one another;

FIG. 2 shows the device from FIG. 1 in a side view, wherein the connector elements, the housing and the positioning part are separated from one another;

FIG. 3 shows the device from FIG. 1 in a perspective view, wherein the housing is arranged in its second position,

FIGS. 4 to 7 show the device from FIG. 1 in a view from below, a top view, a front view and a rear view, wherein the housing is located in its second position; and

FIG. 8 shows an embodiment of a system for electrically contacting a fuel cell assembly having a plurality of bipolar plates in a partial view.

### DETAILED DESCRIPTION OF THE DRAWINGS

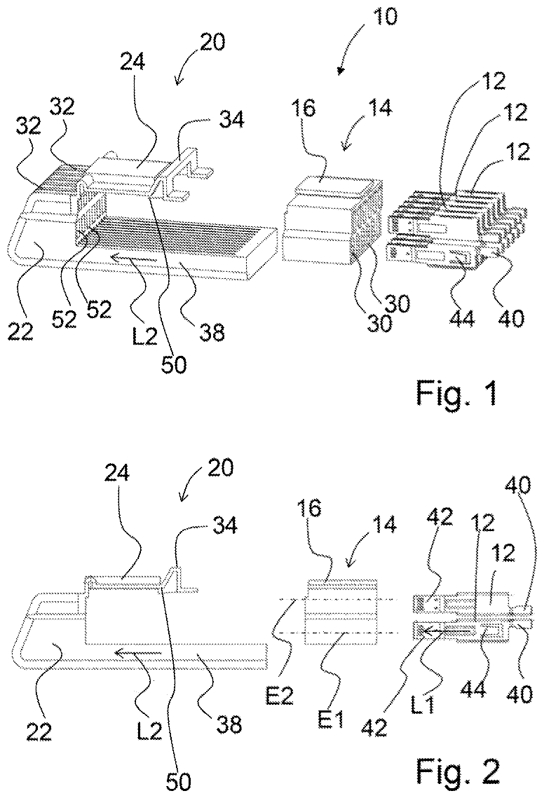

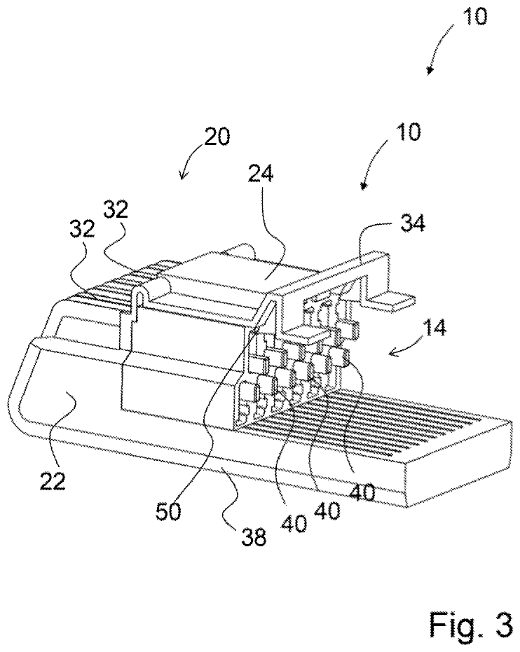

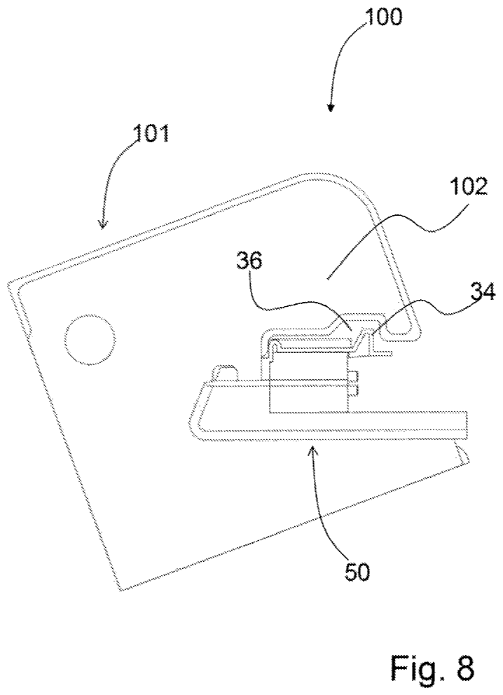

FIGS. 1 and 2 show a device 10 for electrically contacting a fuel cell assembly having a plurality of electrically conductive bipolar plates 101. The fuel cell assembly comprises a plurality of, here for example twelve, individual cells of a fuel cell stack. Each individual cell essentially contains a membrane electrode assembly described at the beginning, the membrane electrode assemblies being arranged between two plates each provided with a fluid duct. The plates of adjacent individual cells together form a bipolar plate 101 which is partially shown in FIG. 8 and in which in each case a contacting portion 102, in the form here in particular of a tab, is arranged. The contacting portion 102 runs parallel to a main plane of the respective bipolar plate. It goes without saying that the bipolar plates 101 are arranged parallel to one another.

The device 10 comprises a plurality of, here for example twelve, connector elements 12, a housing 14 for the connector elements 12, and a separate positioning part 20. All of these components are designed here as separate components which are inserted one into another for use for contacting the bipolar plates 101 at their contacting portions 102, as described in more detail hereinafter. In particular, the positioning part 20 is formed separately from the housing 14 such that the housing 14 can be inserted reversibly into the positioning part 20 and can be removed therefrom without being destroyed. The housing 14 and/or the positioning part 20 are/is designed as a molded part (in particular plastics molded part) and can be produced, for example, by means of injection molding.

The connector elements 12 are all substantially identical (apart from minor manufacturing tolerances). For use as intended, each of the connector elements 12 is designed for electrically connecting to the contacting portion 102 of one of the bipolar plates 101 in each case. According to the refinement of the contacting portion 102 as a tab, each connector element 12 is designed as a flat connector which, at its end facing away from the contacting portion 102, has connection elements 40 for electrical lines (not illustrated) which are provided for electrically connecting to a measuring device of the electrical potentials of the bipolar plates 101. Each of the electrical lines can be connected to the respective connector element 12 in particular by joining by means of plastic deformation (for example crimping) of the associated connection element 40 or thermal joining (for example soldering/welding) to the associated connection element 40. Each connector element 12 has, at its end axially opposite the connection element 40 (in the longitudinal direction L1), a terminal 42 with elastic terminal limbs which, in their inoperative position, are spaced apart by less than the thickness of the contacting portion 102.

The housing 14 has a first guide portion 16 with a slider and a plurality of cutouts into which in each case one of the connector elements 12 is inserted, advantageously before the housing is brought into engagement with the separate positioning part 20. The cutouts are substantially configured as axial through openings 30 and serve substantially to fasten each of the connector elements 12 at a location provided for this connector element 12 relative to the first guide portion 16 (in a form-fitting manner, with some degree of play). For this purpose, each connector element 12 has a latching tab 44 which engages in a latching manner in a latching groove (not shown) on the inner circumferential surface of the respective through opening 30 when the respective connector element 12 is (partially) received in the housing 14. As is shown in FIG. 2, the housing 14 is axially shorter than each of the connector elements 12, and therefore the connector elements 12 protrude out of the housing 14 at both ends of the cutouts.

In order to be able to configure the fuel cell assembly to be more compact, in particular with reduced distances between the bipolar plates 101, the through openings 30 in the housing 14 are formed on a plurality of longitudinal planes E1, E2 running parallel to one another. As shown in FIG. 2, the longitudinal planes E1, E2 each run in particular in the longitudinal direction L1 of a plurality of the connector elements 12 and perpendicularly to the contacting portions 102 when the latter are in engagement with the connector elements 12. In this way, the packing density of the connector elements 12 in the housing 14 can be increased and the center distance between the contacting portions 102 reduced. The connector elements 12 which are arranged along the longitudinal plane E1 and are aligned perpendicularly to this longitudinal plane E1 therefore have, as viewed in the cross section of the housing 14, an offset relative to the connector elements 12, which are arranged along the longitudinal plane E2 and are aligned perpendicularly to this longitudinal plane E2, the relative offset substantially corresponding to the (transverse) distance between the contacting portions 102 when the contacting portions 102 are contacted, as described in detail below.

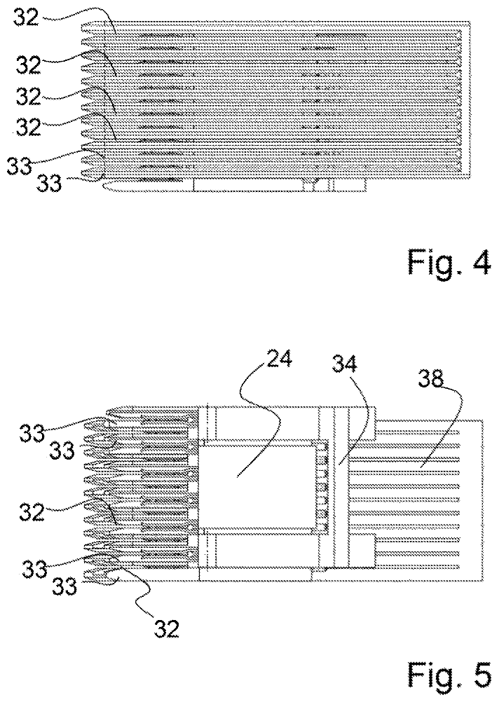

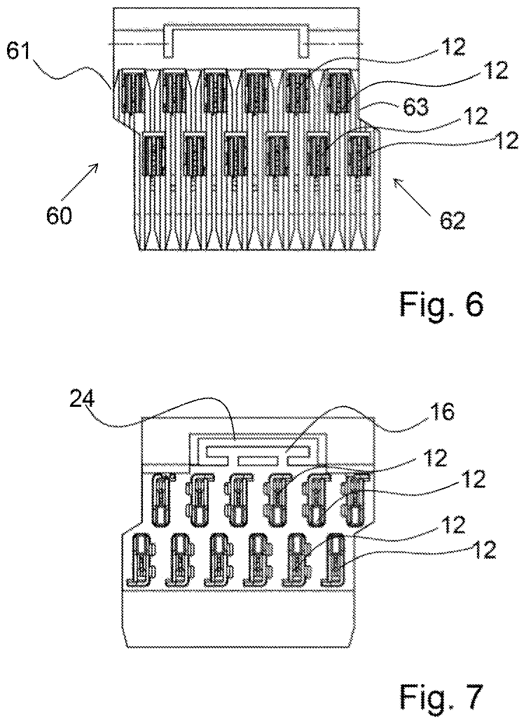

The separate positioning part 20 comprises a holding portion 22 which is designed to hold each of the contacting portions 102 at a position predetermined for it relative to the positioning part 20. For this purpose, the holding portion 22 has a plurality of slots 32 which, in the contacted state, extend from one of the bipolar plates 101 parallel to one another and to the longitudinal direction L2 (main direction of extent) of the positioning part 20 into the positioning part 20. The slots 30 are configured in such a manner that they in each case at least partially clamp one of the contacting portions 102 therein. Furthermore, the positioning part 20 has a second guide portion 24 in the form of a spring-elastic latching arm, which extends from the holding portion 22 parallel to the longitudinal direction L2, with a rail. It should be noted that parallel in this disclosure may mean directed in the same direction or in the opposite direction (i.e. also anti-parallel). The second guide portion 24 is designed to guide the housing 14, by interaction with the first guide portion 16, from a first position in the direction of the holding portion 22 into a second position, which is shown in FIGS. 3 to 7.

The device 10 is used as described below in order to contact the contacting elements 102. The separate positioning part 20 is first of all plugged axially (in the longitudinal direction L2) onto the contacting portions 102 of the bipolar plates 101. Since partitions 33 delimiting the slots 32 taper axially toward the longitudinal-side end of the positioning part 20, one contacting portion 102 is introduced in each case into one of the slots 32. As a result, the distance between the contacting portions 102 is brought to a desired size (in particular equalized) which substantially corresponds to the distance between the center planes of the connector elements 12/terminals.

Starting from the first position of the housing 14 with connector elements 12 inserted in a latching manner in the through openings 30, and in which, in a departure from the illustration from FIGS. 1 and 2, the slider of the housing 14 is in engagement with the rail on the latching arm, in particular is received therein in a form-fitting manner, the housing 14 is shifted in the longitudinal direction L2 in the direction of the holding portion 22. The longitudinal directions L1 and L2 are therefore substantially parallel to each other. As shown in the rear view from FIG. 7, the rail (second guide portion 24) has, in cross section, a profile substantially corresponding to the profile of the slider (first guide portion 16). Since the rail tapers on the inside toward the holding portion 22, the transverse movement of the housing 14 is increasingly restricted transversely during shifting in the longitudinal direction L2 until the housing 14 is fixed in its second position, shown in FIG. 3, in engagement with the positioning part 20 transversely without play. The housing in its second position is clamped in the longitudinal direction L2 between the holding portion 22 and a projection 50 formed on the latching arm.

In this second position, the connector elements 12 project through openings 52 assigned to the slots 32 into the slots 32 in the holding portion 22. In other words, each opening 52 in each case connects one of the slots 32 to a surface of the holding portion 22, the surface facing the housing 14 and on which the openings 52 are open. The openings 52 can therefore be substantially designed as an extension of the through openings 30 and can in particular have the same cross section. While the connector elements 12 in the first position are spaced apart from the contacting portions 102 held by means of the holding portion 22, they reach in the second position as far as the contacting portions 102 such that in each case one contacting portion 102 is clamped between the two terminal limbs of an associated connector element in order to produce an electrical connection between the associated bipolar plate, the connector element and the electrical line leading to the measuring device. The housing 14 is held between the latching arm and a base portion 38 of the positioning part 20, the base portion extending from the holding portion 22 parallel to the latching arm.

FIG. 8 shows part of a system contacted with this device 10 from FIGS. 1 to 7 in the manner described above. The system has the device and the fuel cell assembly having the bipolar plates 101. As illustrated, each of the contacting portions 102 is provided in its edge region with a recess. The contacting portion of the illustrated bipolar plate 101 is clamped between the terminal limbs in the region of this recess. In an overall view of the fuel cell assembly, the device is therefore inserted in the fuel cell assembly, in particular in a receptacle defined by the recesses of adjacent bipolar plates 101. A latching lug 34 of the device engages in a corresponding groove 36 in the contacting portions 102 of mutually adjacent bipolar plates.

It has been stated that the fuel cell assembly may be part of a fuel cell stack. The stack can comprise in particular a plurality of these fuel cell assemblies. For the simple and controlled contacting of one of these fuel cell assemblies after another, the device is formed asymmetrically in a front or rear view along the longitudinal direction L1 or L2. In particular, in this view or in a cross-sectional view, a projection 61 formed on a first longitudinal flank 60 of the device 10 is substantially congruent with a depression 63 formed on a second longitudinal flank 62 of the device 10, which is opposite the first longitudinal flank 60. The devices 10 can therefore be inserted next to one another onto the contacting portions 102 of the bipolar plates 101 with a precise fit. The longitudinal flanks 60, 62 of adjacent devices 10 can contact one another, in particular extensively physically.

1.-15. (canceled)

16. A device for electrically contacting a fuel cell assembly having a plurality of bipolar plates, comprising:
a plurality of connector elements which are each designed to be electrically connected to a contacting portion of one of the bipolar plates;
a housing which has a first guide portion and is designed to at least partially receive the connector elements, wherein the connector elements are at least partially fixed in the housing and are received latching into place in a form-fitting manner; and
a separate positioning part having a holding portion which is designed to hold each of the contacting portions in its own predetermined position relative to the positioning part, and having a second guide portion which is designed to guide the housing from a first position in the direction of the holding portion into a second position by interaction with the first guide portion,
wherein the connector elements at least partially received in the housing are spaced apart in the first position from the contacting portions held via the holding portion and, in the second position, contact the contacting portions held via the holding portion.

17. The device according to claim 16, wherein
the holding portion is designed to at least partially receive and/or clamp the contacting portions.

18. The device according to claim 16, wherein
the holding portion is at least partially arranged between the housing and the contacting portion when the housing is located in the first and/or in the second position.

19. The device according to claim 16, wherein
the positioning part is formed monolithically with the holding portion.

20. The device according to claim 16, wherein
the housing is insertable into a receptacle formed on the positioning part and is removable reversibly from the receptacle.

21. The device according to claim 16, wherein
the connector elements are in the form of terminals which are each designed to clamp an edge portion of one of the contacting portions, and
the terminals are optionally beak-shaped.

22. The device according to claim 16, wherein
the housing is provided with cutouts which are designed to each receive one of the connector elements.

23. The device according to claim 22, wherein
the cutouts in the housing are arranged along a plurality of planes running parallel to one another, and
the planes run perpendicularly to the contacting portions when the holding portion holds the contacting portions and the housing is in the second position.

24. The device according to claim 16, wherein
the holding portion has a plurality of slots which are configured to each partially receive one of the contacting portions in a form-fitting or force-fitting manner.

25. The device according to claim 24, wherein
the slots are aligned parallel with the connector elements when the holding portion holds the contacting portions and the housing is in the second position.

26. The device according to claim 16, wherein
the first guide portion comprises a slider, and the second guide portion comprises a rail, and
the slider is in engagement with the rail in the first position of the housing and in the second position of the housing.

27. The device according to claim 16, wherein
the second guide portion is in the form of a resilient latching arm extending from the holding portion, and
the latching arm has a latching lug for engaging in a corresponding groove in the contacting portions, and/or the housing in the second position is held between the latching arm and a base portion of the positioning part, the base portion extending from the holding portion parallel to the latching arm.

28. The device according to claim 16, wherein
the connector elements are in engagement with the holding portion in the second position of the housing.

29. A system, comprising:
a fuel cell assembly having a plurality of bipolar plates; and
a device according to claim 16,
wherein each of the contacting portions of the bipolar plates has a recess in an edge region for at least partially receiving the device.

30. A method for electrically contacting a fuel cell assembly having a plurality of bipolar plates, comprising:
connecting a plurality of connector elements of an electrically contacting device to a housing of the device, wherein the connector elements are at least partially fixed in the housing and received latching into place in a form-fitting manner, and wherein the housing has a first guide portion and is designed to at least partially receive the connector elements;
connecting a separate positioning part of the device to the contacting portions such that each of the contacting portions is held at its own predetermined position relative to the positioning part, wherein the positioning part has a holding portion which is designed to hold each of the contacting portions in its own predetermined position relative to the positioning part, and has a second guide portion; and
guiding the housing by interaction between the first guide portion and the second guide portion from a first position, in which the connector elements are spaced apart from the contacting portions, in the direction of the holding portion of the positioning part, into a second position in which the connector elements contact the contacting portions.
